(19) United States
(12) Patent Application Publication
(10) Pub. No.: US 2007/0267148 A1
(43) Pub. Date: Nov. 22, 2007

(54) Duct Tape Dispenser

(76) Inventors: Richard W. Steele, Traverse City, MI (US); Wendy Steele, Traverse City, MI (US)

Correspondence Address: NORTHERN MICHIGAN PATENT LAW, PLC, 526 W. FOURTEENTH ST., #250, TRAVERSE CITY, MI, 49684, US

(21) Appl. No.: 11/383,807

(22) Filed: May 17, 2006

(51) Int. Cl. B44C 7/00

(52) U.S. Cl. 156/577

(57) ABSTRACT

A tape dispenser, useful for storing, dispensing, and cutting a roll of duct tape, or similar wide, heavy, hard-to-tear tape. The dispenser has a unique roll-surrounding structure with two sidewalls, a top wall axially extending between the sidewalls above the roll of tape, a spool support extending axially between the sidewalls and through the roll's spool, a retainer bar extending axially between the sidewalls, and an elevated cutting bar located above the top wall and the retainer bar and extending axially between the sidewalls. The dispenser is formed in two axially separable halves. The retainer and cutting bars help connect and strengthen the sidewalls, and are in turn reinforced by the sidewalls and the rest of the dispenser in their tape-retaining and cutting functions. The rigid, axially separable halves of the dispenser are preferably held together with a magnetic connection. The dispenser can also include a bracket that both removably stores the dispenser on the undersurface of a cabinet or the like, and that allows tape to be dispensed and torn with one hand from the bracket-mounted dispenser.

### FIELD OF THE INVENTION

The present invention is in the field of dispensers for pressure-applied adhesive tape.

### BACKGROUND OF THE INVENTION AND DESCRIPTION OF RELATED ART

Dispensers for large rolls of tape have been known for many years. Most seem to be designed for packaging tape. While professional packagers often use heavy, handle-equipped dispensers that look somewhat like large handguns, most dispensers for the average user seem to have split arms that bracket the sidewalls of the roll, with curved or cylindrical spool supports extending inwardly from the split arms into the tape's spool to rotationally support the roll between the arms. The arms extend away from the surface of the roll, and a cutting element is held between the ends of the arms away from the roll, the cutting element oriented generally parallel to the tape-feed direction. The arms typically have spaced guide/retainer tabs associated with the cutting element, apparently to either help direct the tape toward the cutting element when the tape is being applied directly to a package in a continuous strip, and/or to catch and hold the cut end of tape away from the roll's surface. Examples include U.S. Pat. No. 6,719,180 to Shah, and U.S. Pat. No. 6,923,358 to Chandaria.

Another general style of dispenser has an open-faced sidewall with a cylindrical spool support, and a top wall located above a portion of the face of the roll with a cutting element built into the forward end of the top wall. Examples include U.S. Pat. No. 6,695,190 to Gunter, Jr. et al., U.S. Pat. No. 3,134,526 to Schleicher, and U.S. Pat. No. 4,130,229 to Pagnini. These seem to rely on the cutting element to catch and hold the cut end of tape.

An older, third style of tape dispenser that no longer appears to be popular is really more of a minimalist cutting device, in which a cutting element is held directly against the face of the roll of tape by a spool holder rotationally engaging the inner diameter of the roll. Examples include U.S. Pat. No. 2,262,260 to Smith and U.S. Pat. No. 3,970,230 to Horn. These cutters do not appear to have the ability to catch and hold the cut end of tape.

Prior tape dispensers seem to be primarily designed for easily-cut, lightweight tapes such as thin-film packaging tapes and masking tapes. As such they appear to be lightly built, with open housings or thin, flexible members that make them easy to reload with a fresh roll of tape, but that in our opinion make them unsuitable or undesirable for dispensing and cutting one of the most popular and widely used rolls of tape found today in the average household or workshop: duct tape. As a result, duct tape seems to be exclusively sold in plain rolls. Anyone who has used duct tape, known for its width and sticky strength, has likely found it difficult to peel the cut end off the roll and to tear it (requiring both hands) while in the middle of a task.

Another disadvantage of many prior tape dispensers is their apparent lack of utility for conveniently storing a roll of tape between uses, and plain rolls of duct tape are semi-legendary for being misplaced between uses and unavailable when needed. Yet another disadvantage of prior tape dispensers is their inability to provide one-handed dispensing and cutting while stationary.

### BRIEF SUMMARY OF THE INVENTION

The invention is a combined tape dispenser and cutter (hereafter “dispenser”) especially adapted for wide, heavy, hard-to-tear tapes such as duct tape and its equivalents (for example “hundred-mile-an-hour” tape, “duck” tape, “Gorilla™” tape), but also useful for other types and strengths of tape. The dispenser surrounds a circumferential section of the roll of tape (inner spool wall, roll sidewalls, and roll top or outer surface). The dispenser includes a spool support for rotationally mounting a roll of tape, two sidewalls, and a top having top wall, cutting bar, and retainer bar portions circumferentially spaced by tape-stop and tape-feed openings large enough for finger and/or thumb access to the roll on each side of the cutting bar. The cutting bar is vertically offset above the top wall and retainer bar portions, with a horizontal cutting element generally parallel to the roll of tape (and thus generally perpendicular to the tape feed direction). The housing is preferably made from a rigid material that, along with the roll-surrounding nature of the dispenser, gives the user good control and leverage over the roll of tape while dispensing and cutting it.

In a preferred form the dispenser housing is formed from two substantially rigid, axially-separable halves. The top wall, cutting bar, retainer bar, and spool support portions connect and reinforce the sidewalls when the dispenser is assembled. In a further preferred form, at least the spool and tape retainer bar are located on the same half, and optionally all of the reinforcing and supporting members are on the same half.

Another aspect of the invention is a magnetic axial connection between the two axially separable halves of the housing. In the preferred form the housing uses two types of magnetic connection: a shearable magnetic connection using one or more flush-mounted magnets; and a post-and-socket magnetic connection that provides both axial magnetic connection and an anti-rotational, shear-resistant mechanical connection, and that further provides exact indexing of the dispenser halves for ease of assembly. In a further preferred form at least some of the magnetic connections are between free ends of the retainer and cutting bars and the sidewalls.

The dispenser is self-standing in a manner that makes it easy to grasp the roll while preventing the tape from rolling away, and it is conspicuous, reducing the likelihood that the roll of tape will be misplaced. In a further form of the invention, the dispenser has exterior magnets for conveniently storing the dispenser on a metal or magnetic surface. In a further preferred form, the sidewalls of the dispenser have flat outer surfaces to permit stacking (vertically or horizontally) of multiple dispensers, with or without the assistance of exterior magnets. The dispenser also lends itself to being removably coupled to an inventive bracket that securely stores the dispenser under a cabinet or shelf for storage while allowing the tape to be cut and dispensed with one hand from the bracket-supported dispenser. In the most preferred form, the bracket has a cantilevered front arm designed to couple with an exterior magnet on the top of the dispenser.

These and other features and advantages of the invention will become apparent upon further reading of the specification in light of the accompanying drawings.

### BRIEF DESCRIPTION OF THE DRAWINGS

FIG. 1 is a front perspective view of a tape dispenser according to the present invention.

FIG. 2 is a side elevation view of the tape dispenser of FIG. 1, with the cutting and retainer bars, the top wall portion, and some of the spool support and the magnetic connections shown in hidden lines.

FIG. 3 is a top plan view of the dispenser of FIG. 1.

FIG. 4 is a top plan view of an alternate version of the dispenser of FIG. 1 in which the top wall portion is formed by a solid wall.

FIG. 4A is a side elevation view of the dispenser of FIG. 4, with the cutting and retainer bars, the top wall portion, and the spool support shown in hidden lines.

FIG. 5 is an exploded perspective view of the separated dispenser halves of FIG. 1.

FIGS. 6A, 6B, and 7 show dispensers according to either FIGS. 1 or 4 provided with exterior magnets and being magnetically attached to metal storage surfaces and stacked.

FIGS. 8 and 9 are perspective views of dispensers similar to those in FIGS. 1-7, in varying degrees of engagement with inventive undersurface storage brackets that allow tape to be dispensed with one hand.

### DETAILED DESCRIPTION OF THE INVENTION

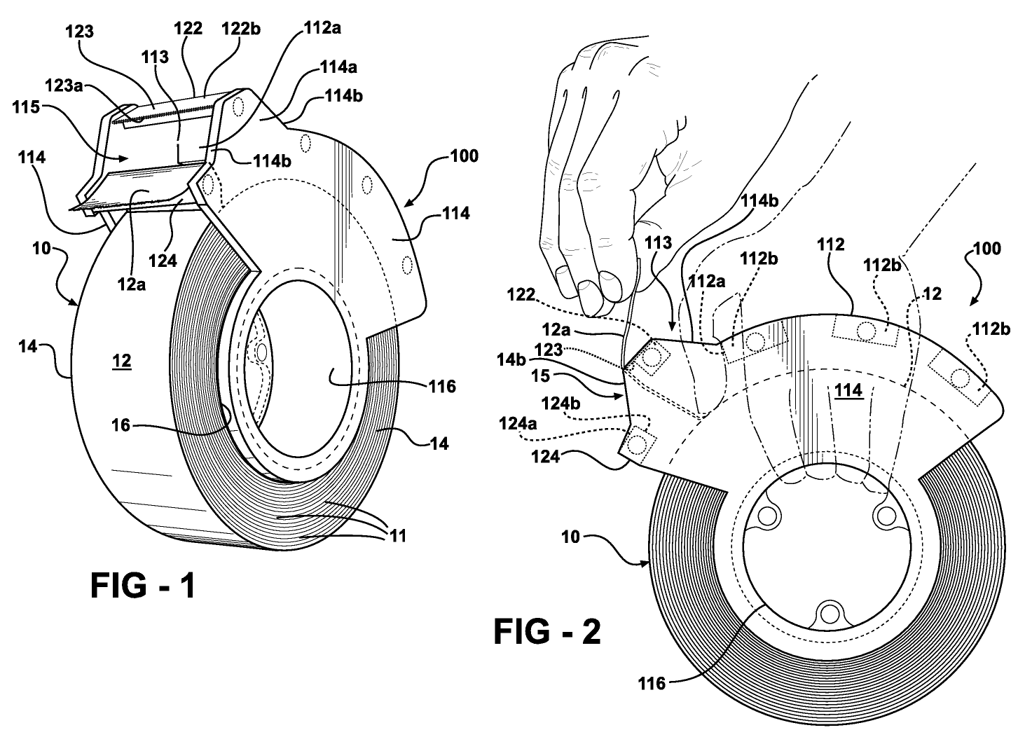

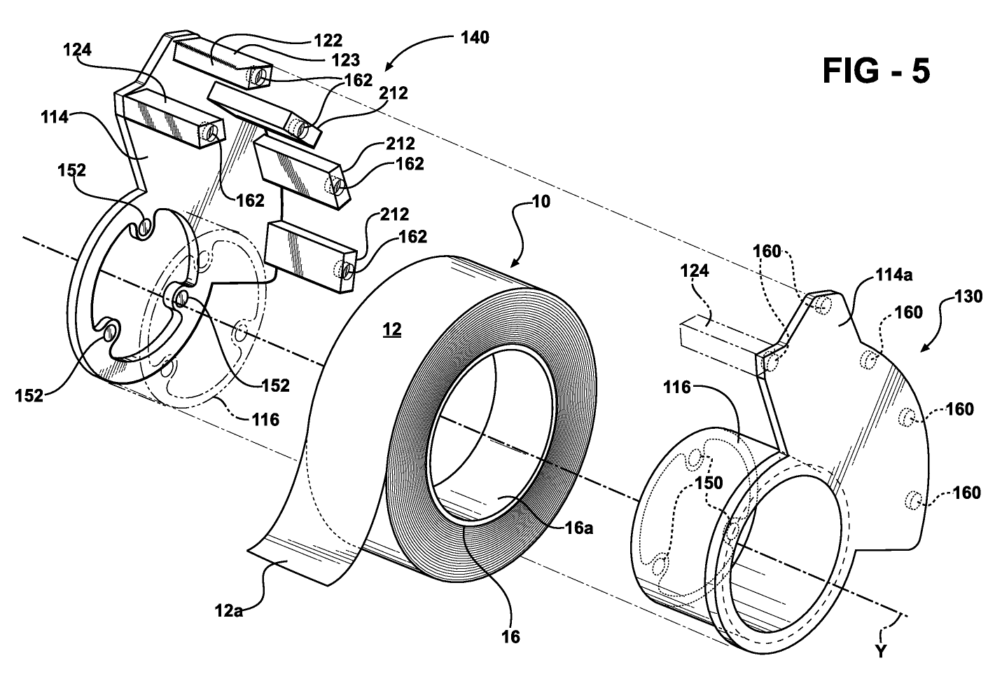

Referring to FIGS. 1 and 2, a common roll of duct tape 10 (most commonly gray, two or three inches wide, heavy, waterproof, hard to tear, possibly reinforced, and sometimes—perhaps originally—called “duck” tape) is shown held in a dispenser 100 according to a preferred example of the present invention. Roll 10 is formed in known manner from multiple layers of tape 11 wound around a spool 16, the spool usually being made of cardboard although other materials are possible. The roll has a top or outer surface 12 consisting of the outermost layer of tape, sides 14 formed by the multiple thicknesses of wound tape (and the spool edges), and an inner diameter or surface 16a (FIG. 5) which is the inner wall of spool 16.

Dispenser 100 has a top wall portion 112 spaced from and generally following the curvature of the outer surface 12 of roll 10; sidewalls 114 spaced from and generally parallel to roll sides 14; and a spool support 116 extending from one dispenser sidewall 114 through spool 16 to the other sidewall 114, the spool support 116 engaging the inner spool diameter 16a with a low friction surface such that roll 10 rotates smoothly and easily on support 116. In the illustrated embodiment, dispenser 100 covers a circumferential section of roll 10, for example extending around approximately a quarter to a third of the roll's circumference. It will be understood that this fraction can vary, and given the tape-feeding and tape-cutting and axially-separable housing structure described in further detail below, it is even possible to extend dispenser 100 substantially all the way around roll 10 to fully enclose the roll.

While in the illustrated embodiment of FIGS. 1 and 2 the spool support 116 is shown as a full cylinder and the dispenser sidewalls 114 are spaced from the sides of roll 10, it will be understood that the spool support could present less than a continuous cylinder surface to the tape spool, and the dispenser sidewalls could engage the sides of the tape roll, provided the friction between the surfaces of the dispenser and the roll of tape are not enough to unduly hinder rotation of the roll in the dispenser.

The forward (tape-dispensing) end of dispenser 100 supports a raised cutting bar 122 spaced farther than top wall 112 from the surface 12 of roll 10, and spaced circumferentially from the forward edge 112a of top wall 112 to leave a tape-stop opening 113. The forward end of the dispenser terminates in a retainer bar 124 spaced from the outer surface 12 of roll 10 approximately the same distance as top wall 112, and circumferentially spaced from cutting bar 122 to leave a tape-feed opening 115. In the preferred, illustrated form, cutting bar 122 is supported between upper ends of raised triangular or trapezoidal portions 114a of sidewalls 114, edges 114b defining the tape-stop and tape-feed openings 113, 115 as substantially planar openings acutely angled with respect to the cutting bar 122.

It should be understood that the term “bar” is not intended to limit the shape or size of the parts so described, except to the extent that they are sufficiently long to connect the sidewalls, and sufficiently strong and rigid to reinforce the assembled halves of the dispenser housing and to withstand the force of the tape being dispensed and cut.

Dispenser 100 is preferably made from a thick-walled, relatively rigid plastic material such that the assembled dispenser 100 is substantially rigid, with little or no flex under the stress of unwinding and tearing tape off roll 10. By way of example, dispenser 100 in the illustrated embodiment has a spool support and side walls on the order of 0.25 inches thick, and the top wall and cutting and retainer bars are preferably as thick or thicker. The illustrated example has been made from cut/machined acrylic and Kydex™ plastics, and other suitable plastics are believed to include, but are not limited to, ABS, polycarbonate, nylons, polypropylenes, and other common plastics, and known molding processes are also believed to be suitable for manufacturing the dispenser. It will also be understood that dispenser 100 could be made from other materials, including wood and metal, or from combinations of the above materials.

The spool support 116, top wall 112, cutting bar 122, and retainer bar 124 bridge the sidewalls 114, axially connecting and reinforcing sidewalls 114 across the roll of tape both above and below the circumferential, annular section of roll 10 encompassed by the dispenser. Coupled with the substantially rigid materials used, this makes dispenser 100 a strong, rigid, easily-controlled platform for dispensing and cutting even heavy, hard-to-tear tape from roll 10.

The upper surface of plastic cutting bar 122 includes a horizontal cutting element 123, in the illustrated embodiment a serrated metal blade of a type known for cutting adhesive tape, with its cutting edge 123a arranged generally parallel or tangential to the adjacent surface of the roll of tape and perpendicular to the tape feed direction off the roll. Cutting element 123 can be secured permanently or removably to the upper face of the cutting bar using any known means or process, including but not limited to adhesives, mechanical fasteners, and plastic welding methods. It will be understood that while a separate metal cutting element is illustrated, cutting elements formed of other materials or molded or machined integrally in the material of cutting bar 122 are possible.

Retainer bar 124 in the preferred, illustrated embodiment has a wide, flat upper surface 124a to hold the leading end 12a of the tape spaced above and preferably at least parallel to the plane of cutting element 123, as best shown in FIG. 2. Surface 124a can also be angled outwardly at an obtuse angle to cutting element 123. And while retainer bar 124 is illustrated with a preferred rectangular cross-section, other cross-sectional shapes such as elliptical or cylindrical or triangular are possible for retainer bar 124.

It will be understood that the edges of the top wall portion 112, the cutting bar 122, and the retainer bar 124 bordering the tape-stop and tape-feed gaps 113, 115 are preferably rounded or beveled to avoid discomfort to a user's fingers.

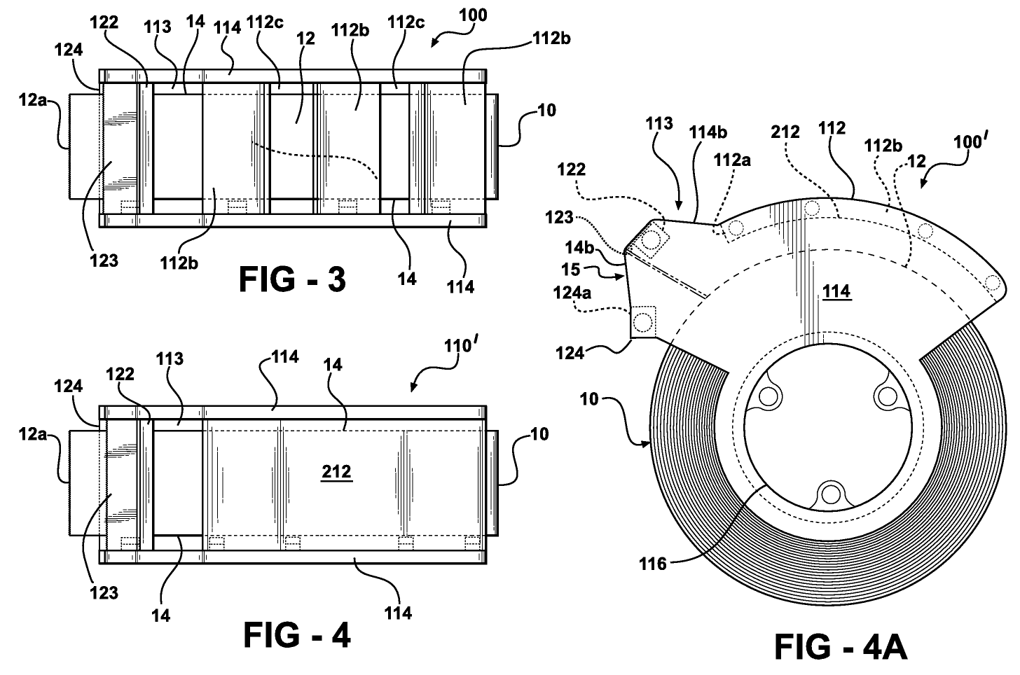

The tape-stop and tape-feed gaps 113 and 115 are planar, acutely-angled (inwardly and upwardly toward the cutting bar) openings defined by the edges 114b of the triangular or trapezoidal “ears” 114a on sidewalls 114. Referring to FIGS. 2 and 3, the angled planar tape-stop gap or opening 113 allows a finger or thumb from the hand holding dispenser 100 to be conveniently and comfortably inserted to control the tape being dispensed and to stop the roll 10 from rotating when a piece of tape dispensed from opening 115 is being cut. The oppositely but similarly angled planar tape-feed gap or opening 115 allows a thumb and forefinger good access to the leading end 12a of the tape held off the face of roll 10 by the retainer bar 124, first to help peel the tape off the retainer bar and then to easily dispense the desired length by pulling it off the roll of tape at a dispensing angle generally perpendicular to the tape roll and to cutting blade 123 before pulling it back across horizontal cutting bar 123 to sever it from the roll. Tape-feed gap 115 also preferably allows peeling and retrieval of the cut end of the tape from the surface of roll 10 for placement onto retainer bar 124 without having to disassemble the dispenser.

Referring to the modified dispenser 100′ in FIGS. 4 and 4A, the top wall portion can be formed continuously rather than by spaced cross-members, in the illustrated embodiment by a solid wall 212 similar in thickness and material to cutting bar 122 and retainer bar 124. If formed discontinuously as in FIGS. 1-3, the gaps 112c between spaced top bars 112b are preferably wide enough to admit a user's fingers, giving the user the option of carrying and controlling the dispenser 100 by grasping the spaced top bars in different ways. It will also be understood that although three spaced top bars 112b are illustrated in FIG. 1, different numbers and placements of spaced top bars are possible where a discontinuous top wall portion is preferred.

Referring next to FIG. 5, dispenser 100 is shown separated into halves 130 and 140, for example to replace an empty roll of tape with a new roll. It should be understood that the use of “halves” to describe the axially separable parts of dispenser 100 is not intended to limit the invention to two identical or symmetrical pieces, but is merely for convenience of explanation. “Axially” separable means that the two halves 130 and 140 separate and re-connect in a direction essentially parallel to the rotational axis γ of tape spool 16.

While various types of known, releasable, mechanical axial connections (for example threaded connectors, male/female, bayonet) could be used to join the halves of dispenser 100, the preferred connection is magnetic, using multiple magnets spaced around the mating inner and outer diameters of halves 130 and 140. The magnets can be secured in appropriately machined or molded sockets in the plastic dispenser, for example with adhesive. In the illustrated embodiment a first set of magnets 150 is located around the perimeter of the outer end of spool support 116, with mating magnets 152 located in a matching pattern on the circular spool-mating portion of the opposite sidewall 114. A second set of magnets 160 placed on the outer free ends or edges of top wall 112, cutting bar 122, and retainer bar 124 mate with magnets 162 located in a matching pattern on the opposite sidewall 114. In the illustrated embodiment, at least some of the magnet connections are post-and-socket type connections to mechanically resist rotational and shear forces tending to separate the dispenser halves 130 and 140 in a direction perpendicular to the assembly axis. For example, while magnets 150, 152 around the mating faces of the spool support 116 and sidewall 114 on dispenser half 140 are set flush with the surrounding plastic material, magnets 160 on the ends of the top wall and cutting and retainer bars project beyond the plastic to form posts or studs while the mating magnets 162 on the sidewall 114 on dispenser half 140 are recessed into the sidewall material to receive the posts.

It will be understood that although a combination of shearable/rotatable flush-mount magnets and post-and-socket type magnetic connections is preferred, the magnetic connections could also be all one type or the other. It should be understood that the term “flush-mount” is intended to include magnets whose faces are exactly flush with the plastic surfaces into which they are set, but also magnets whose faces are recessed into or protruding slightly from the surrounding surfaces, or even sealed within the surrounding surface material, as long as they are capable of making a shearable magnetic connection between the mating parts of the dispenser. It will also be understood that a combination of axial magnetic connections and mechanical anti-rotation/shear connections could be used.

Another optional feature of the invention is the placement of the tape retainer bar 124 on the same sidewall 114 from which the spool support 116 extends, as shown in phantom in FIG. 5. This allows the leading end 12a of the tape to be secured to retainer bar 124 before assembling the dispenser halves together, and prevents the roll of tape from falling off the spool support (and prevents undue stress on the retainer bar) if the leading end of the tape is still attached to the retainer bar when the dispenser halves are separated. Alternately, by placing the retainer bar 124 on the sidewall 114 opposite the spool support 116, the attachment of the leading end 112a of the tape to the retainer bar can help prevent inadvertent separation of the dispenser halves. Yet another option is to place all of the axially projecting wall and support members 112, 122, 124, and 116 on one of the sidewalls, shown by the optional phantom illustration of spool support 116 on dispenser half 140 in FIG. 5; this latter option allows the free end 12a of the tape to be placed securely on retainer bar 124 before the dispenser halves are assembled and makes for easy indexing and assembly of halves 130 and 140.

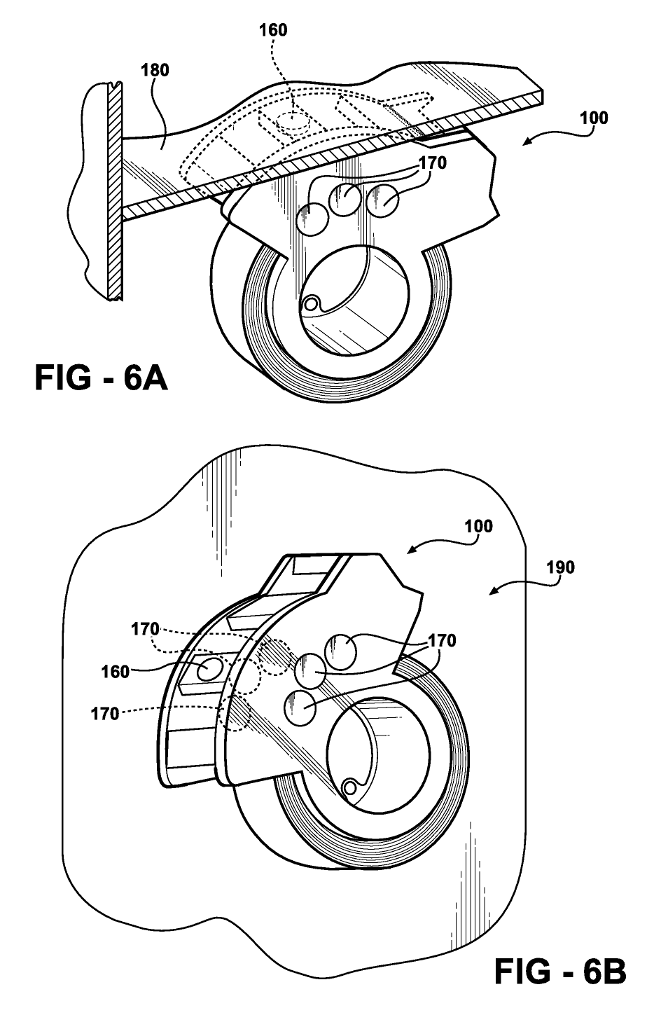

Referring next to FIGS. 6 and 6A, illustrated dispenser 100 is also provided with one or more exterior magnets 160, 170 for attaching the dispenser to a metal work or storage surface. In the preferred, illustrated example, dispenser 100 has upper magnet(s) 160 located on top wall 112 for attaching the dispenser to an overhead surface such as a ferromagnetic rack or shelf 180, and side-mounted magnet(s) 170 for attaching the dispenser to a vertical surface 190 such as a ferromagnetic tool rack or tool box or automotive panel.

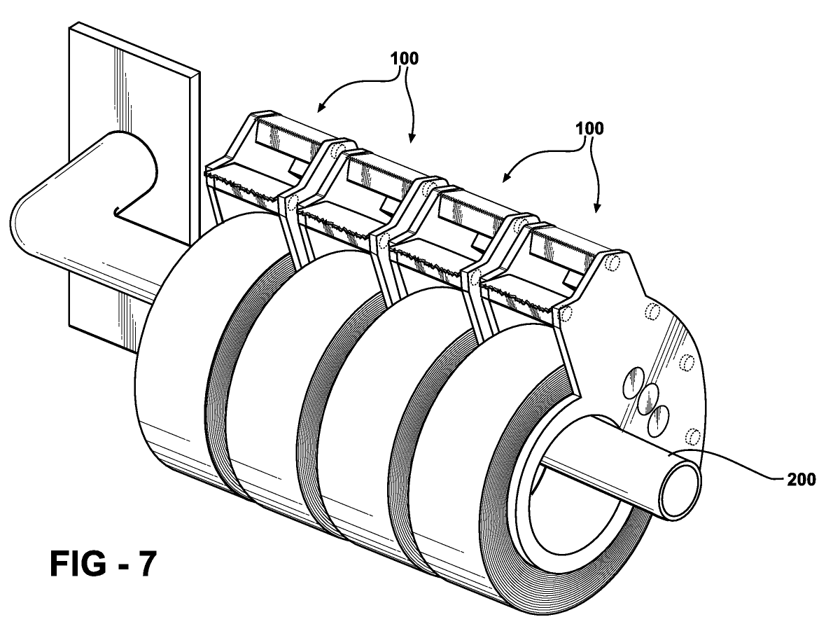

Referring to FIG. 7, sidewalls 114 preferably have flat outer surfaces as shown, to permit multiple dispensers to be stacked. FIG. 7 shows dispensers 100 stacked horizontally on a rack member 200.

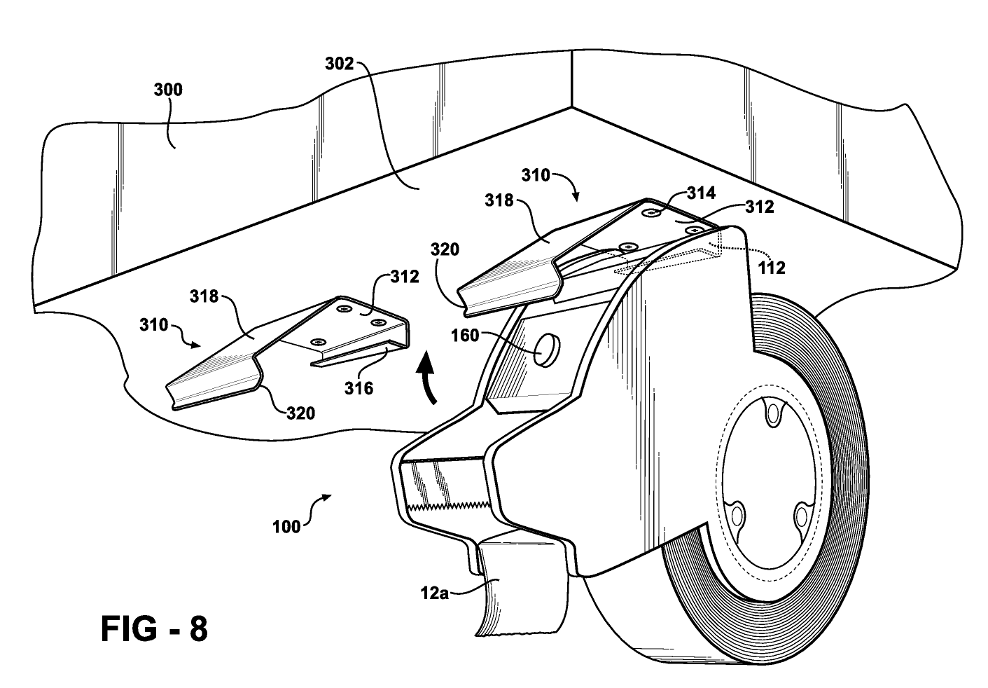

Referring next to FIG. 8, a dispenser 100 similar or identical to those in FIGS. 1-7, and provided with at least the top magnet 160 of FIG. 7, is shown being mounted underneath a cabinet (or shelf or table) 300 using an inventive storage/dispensing bracket 310. Bracket 310 has an upper mounting flat 312 secured with screws 314 (or other known mechanical connections or adhesives, or a strong magnetic connection) to the undersurface 302 of the cabinet; a rear shelf or hook portion 316 adapted to engage and support the rear edge of top wall portion 112 on the dispenser (whether a discrete bar or the end of a continuous wall); and a cantilevered, angled front arm 318 having a front shelf or lip 320 made from a magnetic or ferrous material for being magnetically coupled to the exterior magnet 160 on the top of dispenser 100.

Still referring to FIG. 8, the bracket's horizontal rear shelf 316 and downwardly-angled front arm 318 allow a dispenser 100 to be mounted by sliding the rear edge of top wall portion 112 into the shelf 316, and rotating the front end of the dispenser upwardly until magnet 160 engages bracket front lip 320. Dismounting the dispenser 100 from bracket 310 is simply done in reverse, with the magnetic connection between lip 320 and magnet 160 being broken by prying lip 320 away from the magnet, or by rotating the front end of the dispenser bodily downward away from the bracket with sufficient force to break the magnetic connection, and then sliding the rear edge of the top wall 112 horizontally out of the rear bracket shelf 316.

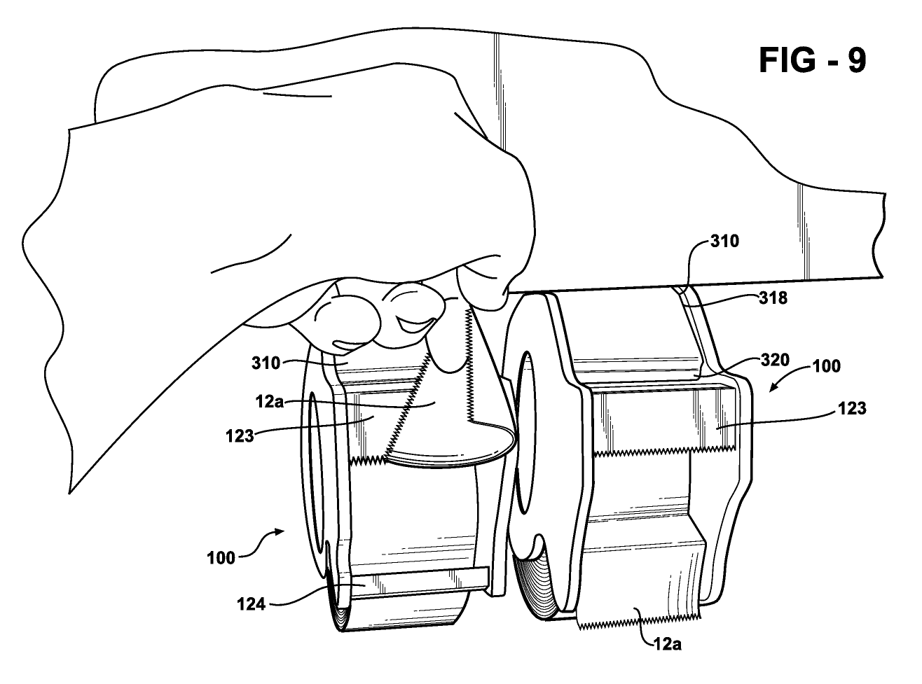

Bracket 310 is preferably substantially rigid, in the illustrated embodiment made from a single piece of steel, such that the upward force of someone tearing tape across cutting element 123 is substantially resisted by the bracket to permit efficient tearing. Bracket 310 is angled to complement dispenser 100 such that the tape feed opening 115 is held generally horizontally or facing downwardly, and the horizontal cutting element 123 is held at a downward-facing angle as best shown in FIG. 9, preferably 90° or less (approximately 45° downward from horizontal in FIG. 8), to facilitate one-handed dispensing and tearing of tape 12 from the bracket-mounted dispenser 100. Multiple dispensers 100 can be mounted side-by-side on multiple brackets 310, if desired.

For further storage and transport options, dispenser 100 can be provided with an integral hook or belt clip on, for example, the exterior of one of sidewalls 114, not shown. It will also be understood that dispenser 100 allows tape roll 10 to be stood on edge on a work or storage surface without rolling away, since the front and rear ends of the dispenser protrude from the roll's surface.

It will be understood that the disclosed embodiments are representative of presently preferred forms of the invention, but are intended to be illustrative rather than definitive of the invention. The scope of the invention is defined by the following claims.

What is claimed is:

1. A tape dispenser adapted to rotatably house a roll of tape, comprising:
two sidewalls, a top wall portion extending axially between the sidewalls and connecting the sidewalls above the outer diameter of a roll of tape contained in the dispenser, a spool support extending axially between the sidewalls and connecting the sidewalls through a spool portion of a roll of tape contained in the dispenser, a retainer bar extending axially between the sidewalls and connecting the sidewalls at a forward end of the dispenser and providing a surface for adhesively securing a leading end of tape from a roll of tape contained in the dispenser, and a cutting bar extending axially between and connecting the sidewalls, the cutting bar being spaced circumferentially and vertically from the retainer bar and from a forward end of the top wall portion to define a tape-stop opening between the top wall portion and the cutting bar and to define a tape-feed opening between the cutting bar and the retainer bar.

2. The tape dispenser of claim 1, wherein the surface for adhesively securing a cut end of tape on the retainer bar is a continuous surface having a width coextensive with a width of a roll of tape contained in the dispenser.

3. The tape dispenser of claim 1, wherein the dispenser comprises two axially separable parts, with a first one of the sidewalls comprising a first axially-separable part and a second one of the sidewalls comprising a second axially-separable part.

4. The tape dispenser of claim 3, wherein the first and second axially-separable parts are connected magnetically.

5. The tape dispenser of claim 4, wherein one of the first and second axially-separable parts comprises a protruding post-type magnet and the other of the first and second axially-separable parts comprises a recessed socket-type magnet sized and shaped to receive the protruding post-type magnet when the first and second axially-separable parts are axially mated, wherein the post-type and socket-type magnets are separable in an axial direction but not in a shear direction.

6. The tape dispenser of claim 4, wherein one of the first and second axially-separable parts comprises a first flush-mounted magnet and the other of the first and second axially-separable parts comprises a mating second flush-mounted magnet, the mating first and second flush-mounted magnets being separable in both axial and shear directions.

7. The tape dispenser of claim 4, wherein one of the first and second axially-separable parts comprises a protruding post-type magnet and the other of the first and second axially-separable parts comprises a recessed socket-type magnet sized and shaped to receive the protruding post-type magnet when the first and second axially-separable parts are axially mated, the post-type and socket-type magnets being separable in an axial direction but not in a shear direction, and further wherein one of the first and second axially-separable parts comprises a first flush-mounted magnet and the other of the first and second axially-separable parts comprises a mating second flush-mounted magnet, the mating first and second flush-mounted magnets being separable in both axial and shear directions.

8. The tape dispenser of claim 7, wherein the post-type magnet is located on a free end of one of the retainer bar, cutting bar, and top wall portion, and the socket-type magnet is located on a portion of the sidewall mating with the free end of one of the retainer bar, cutting bar, and top wall portion.

9. The tape dispenser of claim 8, wherein one of the flush-mounted magnets is located on a free end of the spool support, and the other of the flush-mounted magnets is located on a portion of the sidewall mating with the free end of the spool support.

10. The tape dispenser of claim 3, wherein the retainer bar, cutting bar, top wall, and spool support are permanently connected at first ends to one of the sidewalls and removably connected at free ends to another of the sidewalls.

11. The tape dispenser of claim 10, wherein the retainer bar is removably connected at its free end to a first sidewall, and the cutting bar, top wall, and spool support are permanently connected at their free ends to the first sidewall.

12. The tape dispenser of claim 10, wherein the retainer bar, the cutting bar, the top wall portion, and the spool support are permanently connected at their free ends to the first sidewall.

13. The tape dispenser of claim 1, further comprising one or more exterior magnets for magnetically attaching the dispenser to a ferromagnetic object.

14. The tape dispenser of claim 12, wherein the one or more exterior magnets comprises a first upper magnet located on the top wall of the dispenser, and a second side magnet located on one of the sidewalls.

15. The tape dispenser of claim 1, wherein the sidewalls have substantially flat exterior surfaces that permit multiple dispensers to be stacked sidewall-to-sidewall.

16. The tape dispenser of claim 13, the dispenser comprising an exterior magnet on the top wall portion, and further comprising a separate bracket for removably storing the dispenser on the undersurface of a cabinet or the like, the bracket being adapted to be permanently mounted to the undersurface, the bracket having a rear end adapted to releasably engage a rear portion of the top wall portion of the dispenser, and the bracket having a downwardly-angled cantilevered front arm adapted to magnetically couple with the exterior magnet on the upper surface of the dispenser, such that the tape feed opening is held horizontally or downward and a cutting element on the cutting bar is held at a downward angle to facilitate one-handed dispensing and tearing of tape from the bracket-mounted dispenser.
